(19) United States
(12) Patent Application Publication
(10) Pub. No.: US 2024/0035628 A1
(43) Pub. Date: Feb. 1, 2024

(54) METHODS FOR MEASURING BED HEIGHT AND DEPOSITION VELOCITY IN SLURRY TRANSPORT PIPELINES

(71) Applicant: SYNCRUDE CANADA LTD. in trust for the owners of the Syncrude Project as such owners exist now and in, Edmonton (CA)

(72) Inventors: Kevin REID, Edmonton (CA); Tim REVEGA, Edmonton (CA); Trevor HOUTSTRA, Edmonton (CA); Caitlin LEE, Edmonton (CA); Ryan SPELAY, Edmonton (CA)

(21) Appl. No.: 18/360,671

(22) Filed: Jul. 27, 2023

Related U.S. Application Data
(60) Provisional application No. 63/392,954, filed on Jul. 28, 2022.

(51) Int. Cl. F17D 5/00; F17D 3/01

(52) U.S. Cl. CPC F17D 5/00; F17D 3/01

(57) ABSTRACT

A method for determining a bed height of a solids bed formed in a pipeline transporting an oil sands slurry is described. The method can include measuring an actual flow rate of the slurry, obtaining at least one measured velocity, determining a velocity derived flow rate from the measured velocity and a cross-sectional area of the pipeline, determining a cross-sectional bed area to then determine the bed height. A process for operating a pipeline transporting a slurry including the method for determining the bed dimension is also provided. Bed height determination and control can help mitigate slurry pipeline wear.

### RELATED PATENT APPLICATION

This patent application claims benefit of U.S. provisional application No. 63/392,954, which is incorporated herein by reference.

### TECHNICAL FIELD

The technical field generally relates to solids bed formation inside a pipeline transporting a slurry.

### BACKGROUND

The wear on slurry transportation pipelines within the oil sands industry is a major driver of both downtime and capital expenditure. Oil sand slurries are often reasonably concentrated in solid particles (>25% solids by volume), typically having a sand particle diameter between 0.12 and 0.35 mm, and rocks and lumps of a diameter reaching about 125 mm. For some slurries, these solids are transported at rather high velocities (3 to 5.5 m/s) in the pipeline. In an oil sands mining operation, numerous pipelines transport settling slurries. Two existing major slurry pipeline systems in oil sands mining and extraction operations, among others, are oil sand hydrotransport pipelines, carrying concentrated slurries of oil sands and water from the mine to the extraction plant; and coarse tailings pipelines, carrying concentrated slurries of sand, clay fines and water from the extraction plant to the sand storage/disposal area. Other examples include coke slurry pipelines transporting coke produced during upgrading and composite tailings pipelines.

As with most conventional slurry pipelines, oil sands slurry pipelines are operated above a threshold operating velocity to ensure that a blockage does not form due to the deposition of solids contained in the slurry. This threshold velocity is known as the deposition velocity, or the velocity at which solids start to settle at the bottom of the pipeline. Generally, the minimum operating velocity is kept at 0.5 m/s above the deposition velocity (Kaushai et al., (2002) Powder Technology, vol. 125, Issue 1, 89-101). The deposition velocity is commonly measured in laboratory settings by locating a gamma ray densitometer at 5% of the pipe diameter from the lower pipe surface. The density at this location is then monitored while the slurry velocity is decreased. When the density of the solids at the bottom of the pipe reaches a value corresponding to the solid packing density for a particular solid particle, the deposition velocity is considered to have been reached. If the velocity of the slurry circulating inside the pipeline is reduced further below the deposition velocity, the pipeline will become progressively more filled with a bed of particles until the pumping capacity of the system is not able to overcome the increased pressure gradient within the pipeline. At this point, it is necessary to shut the system down to clear out the blockage and the pipeline can be said to have “sanded-off”. Thus, for a given volumetric throughput of material, the pipeline diameter must be chosen to ensure that solid deposition does not occur. In the design of industrial scale pipelines, computerized models are used to predict the deposition velocity a priori. The deposition velocity as measured in a laboratory setting is included in these computerized models and the models can then be used to predict the deposition velocity within commercial pipelines.

It was previously shown by the Applicant that, when operating a conventional oil sand slurry pipeline at relatively high velocities (i.e., above the deposition velocity), the greatest erosion occurs at the 6 o'clock position of the pipe, i.e., the pipe bottom. It was also surprisingly discovered by the Applicant that by operating the slurry transportation pipeline near or below the deposition velocity (i.e., at stationary bed conditions), a decreased wear of the pipe was observed thanks to the formation of a protective stationary bed at the 6 o'clock position of the pipe (see Canadian Patent No. 2,870,976).

Thus, by operating the slurry pipeline near or below deposition velocity, wearing of the pipeline, especially at the 6 o'clock position, can be reduced, thereby increasing the projected life of the pipeline.

It is thus relevant to be able to measure the relative bed height to the diameter of the pipeline (y/D) and the deposition velocity, i.e., at what velocity a deposit will start to form, to ensure that the pipeline is operated optimally in this operational mode. If the solids bed becomes too large, operability issues can occur, as described above, and if the solids bed is too low then the wear prevention effects can be compromised.

Hence, there is a need in the industry for methods to determine bed height, deposition velocity and/or other relevant variables in a slurry pipeline.

### SUMMARY

In accordance with an aspect, there is provided a method for determining a bed dimension of a solids bed formed in a pipeline transporting an oil sands slurry, the method including: measuring an actual flow rate of (Q_{actual}) the slurry being transported through the pipeline; obtaining at least one measured velocity (Vᵢₙₛₜᵣᵤₘₑₙₜ) of the slurry being transported; determining a velocity-derived flow rate (Qᵢₙₛₜᵣᵤₘₑₙₜ) based on Vᵢₙₛₜᵣᵤₘₑₙₜ and a cross-sectional size property of the pipeline; determining a cross-sectional bed size property based on a flow rate difference (ΔQ) between the Qᵢₙₛₜᵣᵤₘₑₙₜ and the Q_{actual} as well as the Vᵢₙₛₜᵣᵤₘₑₙₜ; and determining the bed dimension based on the cross-sectional bed size property.

In some implementations, the bed dimension is a bed height.

In some implementations, the cross-sectional size property of the pipeline is the cross-sectional area of the pipeline (Aₚᵢₚₑ), the cross-sectional bed size property is a cross-sectional bed area (A_{bed}) and the bed height is determined based on the A_{bed}.

In some implementations, the Qᵢₙₛₜᵣᵤₘₑₙₜ is determined by multiplying the Vᵢₙₛₜᵣᵤₘₑₙₜ by the Aₚᵢₚₑ.

In some implementations, the A_{bed} is determined by the following: (Qᵢₙₛₜᵣᵤₘₑₙₜ−Q_{actual})/Vᵢₙₛₜᵣᵤₘₑₙₜ.

In some implementations, the bed dimension is determined using the cross-sectional bed size property according to a trigonometrical relationship.

In some implementations, the trigonometrical relationship comprises a disk segment equation.

In some implementations, the disk segment equation is

$${A}_{bed} = \frac{{D}^{2}}{4} {cos}^{- 1} ( 1 - 2 ( \frac{y}{D} ) ) - ( \frac{D}{2} - y ) \sqrt{( Dy - {y}^{2} )} ,$$

wherein D is a diameter of the pipeline, and y is the bed height.

In some implementations, determining the bed dimension is performed using an iterative process.

In some implementations, measuring of the Q_{actual} is performed using a volume flow meter or a mass flow meter and density measurement.

In some implementations, the mass flow meter is an electromagnetic flow meter, and the volume flow meter is a sonar-based flow meter.

In some implementations, the Vᵢₙₛₜᵣᵤₘₑₙₜ is measured using a sonar-based flow meter.

In some implementations, the Vᵢₙₛₜᵣᵤₘₑₙₜ is measured as a single velocity at or near a centerline of the pipeline.

In some implementations, the Vᵢₙₛₜᵣᵤₘₑₙₜ is determined based on at least two velocity measurements taken at different heights in the pipeline.

In some implementations, the at least two velocity measurements are taken between a top of the pipeline and a 3 o'clock position of the pipeline.

In some implementations, the slurry is a hydrotransport slurry supplied from a Slurry Preparation Plant to a primary bitumen separation unit, or a tailings slurry comprising coarse mineral solids.

According to another aspect, there is provided a method for determining a deposition velocity of a of a solids bed formed in a pipeline transporting an oil sands slurry, the method including: obtaining a no-bed velocity when no solids bed is formed in the pipeline; and obtaining at least one measured velocity of the slurry being transported; wherein the at least one measured velocity is greater than the no-bed velocity.

In some implementations, the method further includes using a correlation linking the measured velocity data to the no-bed velocity data, the correlation providing a deviation corresponding to a first indication of the deposition velocity.

According to another aspect, there is provided a process for operating a pipeline transporting a slurry, including: pumping a slurry flow through a pipeline; monitoring the slurry and determining the bed dimension according to the method described above for determining a bed dimension; and adjusting operating conditions of the slurry based at least in part on the bed dimension.

In some implementations, the adjusting of the operating conditions includes decreasing a flow rate of the slurry to increase the bed dimension or increasing the flow rate of the slurry to decrease the bed dimension.

In some implementations, the method further includes controlling the bed dimension by adjusting the slurry flow, by adjusting a tonnage for a given water flow rate or by adjusting a viscosity of the slurry.

In some implementations, adjusting the viscosity of the slurry is completed by feeding to the pipeline an ore with a higher clay particles content.

In some implementations, the bed dimension is a bed height which is maintained between 5% and 25% of a diameter of the pipeline.

In some implementations, the process described above further includes obtaining a plurality of Vᵢₙₛₜᵣᵤₘₑₙₜ readings at respective locations along the pipeline and determining corresponding bed dimensions at the locations.

In some implementations, a first bed dimension is determined at a first location of an oil sands hydrotransport pipeline and a second bed dimension is determined at a second location that is downstream from the first location, and the slurry flow is adapted based on the first and second bed dimensions.

### BRIEF DESCRIPTION OF THE DRAWINGS

The attached figures illustrate various features, aspects and implementations of the technology described herein.

FIG. 1 is a schematic example implementation of a slurry pipeline.

FIG. 2 is a schematic example implementation of a slurry pipeline.

FIG. 3 is a transverse cut schematic view of a slurry pipeline.

FIG. 4 is a schematic example implementation of a slurry pipeline in which no bed is formed.

FIG. 5 is a graph of a CiDRA SONARtrac™ velocity (m/s) versus an actual velocity (m/s).

FIG. 6A is a block diagram of a process for operating a slurry pipeline incorporating the determination method, wherein a flow rate increase is performed.

FIG. 6B is a block diagram of a process for operating a slurry pipeline incorporating the determination method, wherein a flow rate decrease is performed.

FIG. 7 is a block diagram of a process for operating a hydrotransport slurry pipeline and a coarse tailings slurry pipeline.

FIG. 8 is a graph showing the variation of the flow difference obtained by the method with a slurry flow rate when a bed is formed.

FIG. 9A is graph comparing a true bed height and a calculated bed height using a CiDRA SONARtrac™.

FIG. 9B is a graph comparing a true bed height and a calculated bed height using a CiDRA SandTrac™.

FIG. 10 is a graph comparing a true bed height (observed) and a calculated bed height.

### DETAILED DESCRIPTION

Methods and processes are described for measuring a bed dimension of a solids bed formed at a bottom of a pipeline transporting a slurry. More particularly, instrumentation can be used to measure velocities and flow rates of a slurry circulating through a pipeline in order to determine the bed dimension and, in some cases, a deposition velocity to optimize operation of the pipeline. As used herein, “slurry” is defined as a mixture of solid(s) with a liquid (usually water) which is capable of being pumped through a slurry pipeline.

More broadly, the present description relates to a method for determining a bed dimension (e.g., bed height) of a solids bed formed in a pipeline transporting an oil sands slurry. The method includes measuring an actual flow rate (Q_{actual}) of the slurry being transported through the pipeline; obtaining at least one measured velocity (Vᵢₙₛₜᵣᵤₘₑₙₜ) of the slurry being transported; determining a velocity-derived flow rate (Qᵢₙₛₜᵣᵤₘₑₙₜ) based on Vᵢₙₛₜᵣᵤₘₑₙₜ and a cross-sectional size property (e.g., area) of the pipeline; determining a cross-sectional bed size property (e.g., area) based on a flow rate difference (ΔQ) between the Qᵢₙₛₜᵣᵤₘₑₙₜ and the Q_{actual} as well as the Vᵢₙₛₜᵣᵤₘₑₙₜ; and determining the bed dimension based on the cross-sectional bed size property. More details regarding examples and implementations of the determination method will be described below.

Among others, two types of continuously operated slurry transport pipelines can be used in the sand oils industry: 1) oil sands hydrotransport pipelines, which can be of about 3 to 5 km long, and 2) coarse tailings pipelines, which can be of about 10 km long. Hydrotransport pipelines can be composed of either carbon steel (CS) or stainless steel (SS) pipe or non-metallic lined piping (e.g., rubber, urethane, etc.) having an inner diameter of about 27″ to about 30″. Generally, the thickness of the wall of the pipe can range between about 1/2″ and about 3/4″ for metallic piping. Coarse tailings pipelines can also be made of carbon steel or stainless steel or non-metallic lined piping (e.g., rubber, urethane, etc.) having an inner diameter of about 23″ to about 30″. Generally, the thickness of the wall of the pipe can also range between about 1/2″ and about 3/4″ for metallic piping.

It was discovered that by operating slurry transport pipelines with a stationary bed having a height less than about 25% of the diameter of the pipeline (i.e., a relative bed height (y/D) of about 0.25, where y=bed height and D=diameter of the pipeline) but greater than about 5% of the diameter of the pipeline (i.e., a relative bed height of about 0.05), a reduced pipeline wear, especially at the 6 o'clock position of the pipeline, was observed. This can be accomplished by operating near or below the deposition velocity of the particular slurry pipeline. Monitoring bed geometry and, in some implementations, the deposition velocity, can thus be beneficial to ensure that a sufficient bed is formed to reduce pipeline wear at the 6 o'clock position and that the pipeline does not sand off. Details regarding the method for determining a specific bed dimension are provided below.

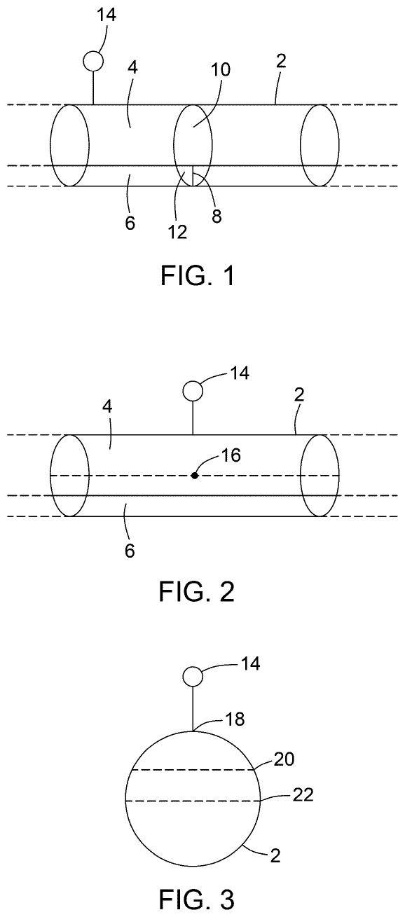

FIG. 1 shows a pipeline 2 transporting oil sands slurry 4 and including a solids bed 6. A method for determining a bed dimension 8 (e.g., bed height) of the solids bed 6 formed in the pipeline 2 is provided below. Several parameters can be determined in order to determine the presence of the solids bed 6 and define dimensions of the solids bed 6. An actual flow rate (Q_{actual}) and at least one measured velocity (Vᵢₙₛₜᵣᵤₘₑₙₜ) of the slurry 4 can be measured by a flow meter 14. Based on the at least one measured velocity and a cross-sectional size property 10, a velocity-derived flow rate can be determined (Qᵢₙₛₜᵣᵤₘₑₙₜ). Then, a cross-sectional bed size property 12 can be determined based on a flow rate difference (ΔQ) between the Qᵢₙₛₜᵣᵤₘₑₙₜ and the Q_{actual} as well as the Vᵢₙₛₜᵣᵤₘₑₙₜ. The cross-sectional bed size property 12 can be used to define the bed dimension 8. In some implementations, the bed dimension 8 can be a bed height. The cross-sectional size property 10 of the pipeline 2 can be the cross-sectional area of the pipeline (Aₚᵢₚₑ), the cross-sectional bed size property 12 can be a cross-sectional bed area (A_{bed}) and the bed height can be determined based on the A_{bed}.

### Flow Rate Measurements and Bed Dimension Implementations

As described above, at least two flow rates of the slurry 4 can be measured or calculated based on other measured parameters.

Referring to FIG. 1, the actual flow rate (Q_{actual}) can be determined using measured quantities of ore and water used to form the slurry and/or could be measured by using a flow meter 14. The Q_{actual} can be obtained by measuring the flow rate in a section of the pipeline 2 where no bed is formed or where the slurry velocity is known to be above the deposition velocity. The flow meter 14 can be a sonar-based flow meter such as a CiDRA SONARtrac™ or a CiDRA SandTrac™. Several other types of flow meters can be used to determine the actual flow rate such as electromagnetic flow meters and venturi meters. Coriolis flow meters can also be used.

For the present methods, volumetric flow meters can be preferred to mass flow meters since a measured mass flow rate is to be converted into a volumetric flow rate by using a density of the slurry. This additional measurement can introduce an unnecessary measurement error.

The CiDRA SONARtrac™ can be used to measure a centerline velocity in a slurry pipeline. The CiDRA SandTrac™ instrument can be used to measure a plurality of velocities in a slurry pipeline, for example, at a top of the pipe, at a quarter-line of the pipe and at a centerline of the pipe. One or both of these instruments can be used to measure slurry velocities used in the present methods such as an equipment using electrical resistance tomography.

The SandTrac™ instrument can be aimed at determining an onset of deposition; unfortunately, however, the SandTrac™ instrument alone, without the method as described herein, can only indicate whether a bed exists or not but cannot help to provide a relative bed height or an actual bed height of the solids bed. It is understood, however, that any instrument that can measure or approximate at least the centerline velocity in a slurry pipeline can be used. For example, an electromagnetic flow meter with the electrodes located at the 3 and 9 o'clock position of the pipe could also be used to obtain measurements that are used to derive the centerline velocity. However, it is noted that sonar-based flow meters can be more relevant for the purposes of the present method compared to other types of flow meters since such flow meters can provide information on velocity and flow rate. Sonar-based flow meters can non-intrusively measure the Vᵢₙₛₜᵣᵤₘₑₙₜ within the pipeline 2 then leverage the Vᵢₙₛₜᵣᵤₘₑₙₜ to obtain Q_{actual} by using the cross-sectional size property 10.

In view of the above and referring to FIG. 2, Vᵢₙₛₜᵣᵤₘₑₙₜ can be determined based on a single velocity at or near a centerline 16 of the pipeline 2 via the use of a flow meter 14 such as SONARtrac™. By “near” it can be understood that it is within 1-5% of the diameter of the pipeline. Referring now to FIG. 3, Vᵢₙₛₜᵣᵤₘₑₙₜ can be determined based on at least two velocity measurements taken at different heights in the pipeline 2 by the flow meter 14. For instance, the at least two velocities can be taken between a top 18 of the pipeline 2, a 1.5 o'clock position 20 and a 3 o'clock position 22 of the pipeline 2 by using a SandTrac™ flow meter.

Whichever instrument is used, the flow meter 14 can be generally clamped onto an outside surface of the pipeline 2 and can be positioned at a location where the pipeline 2 is operating with a bed, i.e., at a position where the pipeline 2 is operating near or below the deposition velocity. The Q_{actual} measured can then be compared with the velocity derived flow rate (Qᵢₙₛₜᵣᵤₘₑₙₜ). The Q_{actual} in examples below was calculated using the ore tonnage (measured using a weightometer) and the slurry water (measured using a magnetic flow meter on the water piping). The Q_{actual} can also be measured on a reduced diameter horizontal pipe section or the same (or reduced) diameter section of vertical piping.

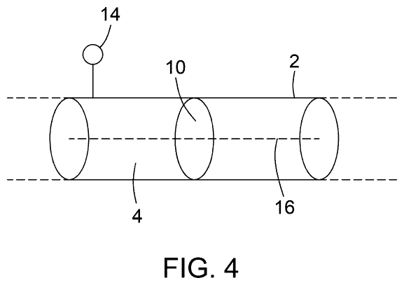

When the flow meter 14 such as a sonar-based flow meter is used on the pipeline 2 where no bed of solids has formed, determining Qᵢₙₛₜᵣᵤₘₑₙₜ can be quite straightforward, as shown in FIG. 4. When the Vᵢₙₛₜᵣᵤₘₑₙₜ in the pipeline has been measured at the centerline 16 of the pipeline 2 and the cross-sectional area 10 is known, the Qᵢₙₛₜᵣᵤₘₑₙₜ can be determined by multiplying the Vᵢₙₛₜᵣᵤₘₑₙₜ by the Aₚᵢₚₑ. Referring to FIG. 4, Aₚᵢₚₑ can be seen as the cross-sectional size property.

It was observed, however, that when a same flow meter is installed on a portion of the pipeline 2 operating with a solids bed 6, the Qᵢₙₛₜᵣᵤₘₑₙₜ of the slurry 4 was measured to be much higher than the actual flow rate. The reason for this high Qᵢₙₛₜᵣᵤₘₑₙₜ can be explained by the fact that when a solids bed is present in the pipeline 2, a centerline velocity measured in the pipeline 2 can be associated with a flow rate of a slurry circulating in an area above the solids bed 6. Thus, to accurately calculate Qᵢₙₛₜᵣᵤₘₑₙₜ would require that the open area of the pipeline, i.e., the area above the bed, is known a priori. This area is referred to herein as Aₒₚₑₙ. The velocity above the bed (referred to here as Vᵢₙₛₜᵣᵤₘₑₙₜ), the flow area above the bed (Aₒₚₑₙ) and the area of the bed (A_{bed}) should all be known to accurately calculate the flow rate when a bed of solids has formed.

However, since the bed height is not known a priori, Aₒₚₑₙ is also not known. Thus, when there is a solids bed in the pipeline 2, the flow meter 14 such as the sonar-based flow meter can calculate the Qᵢₙₛₜᵣᵤₘₑₙₜ using the product of Vᵢₙₛₜᵣᵤₘₑₙₜ and Aₚᵢₚₑ, thereby leading to an overestimate of the flow rate when the solids bed 6 is present. If the Q_{actual} in the pipeline 2 (i.e., without a bed, when Aₒₚₑₙ can be referred to as A_{no bed}) is known, either using the flow meter 14 such as the sonar-based flow meter on a vertical portion of piping or on a portion of pipeline 2 that can operate above deposition velocity or using the ore and water addition rates, the Qᵢₙₛₜᵣᵤₘₑₙₜ measured when a solids bed is present can be used to measure the bed height and to estimate the deposition velocity. In the experiments performed in the examples below, a sonar-based flow meter was used. In particular, either the SONARtrac™ or the SandTrac™ instrument was used. Hence, the flow rate determined by the either the SONARtrac™ or the SandTrac™ instrument is referred to in the following equations as Qᵢₙₛₜᵣᵤₘₑₙₜ

ΔQ=Qᵢₙₛₜᵣᵤₘₑₙₜ−Q_{actual} Eq. 1

Q_{actual}=VᵢₙₛₜᵣᵤₘₑₙₜAₒₚₑₙ=VᵢₙₛₜᵣᵤₘₑₙₜA_{no bed} Eq. 2

Qᵢₙₛₜᵣᵤₘₑₙₜ=VᵢₙₛₜᵣᵤₘₑₙₜAₚᵢₚₑ Eq. 3

Aₚᵢₚₑ=A_{bed}+Aₒₚₑₙ Eq. 4

These equations can be used to show Equation 5 below:

$${A}_{bed} = \frac{Δ Q}{{V}_{instrument}} \qquad Eq . 5$$

Referring to FIG. 1, the bed height 8 can be determined by using the cross-sectional bed area 12 Aₚᵢₚₑ when no solids bed is formed, in a trigonometrical relationship. The trigonometrical relationship can be a disk segment equation given by Equation 6 below, wherein D is a diameter of the pipeline, and y is the bed height:

$${A}_{bed} = \frac{{D}^{2}}{4} {cos}^{- 1} ( 1 - 2 ( \frac{y}{D} ) ) - ( \frac{D}{2} - y ) \sqrt{( Dy - {y}^{2} )} \qquad Eq . 6$$

The bed height (y) can be found by using a mathematical iterative process, for example by using a computational software, rather than solving the above equation for y. Goal seeking, also referred to as backsolving, can be an example of a suitable computational method to solve Eq. 6. Dedicated programs or software such as Microsoft Excel® can be used to perform goal seeking. It is noted that other trigonometrical equations could be used to determine the bed height or other bed size property that may be of interest.

### Deposition Velocity Implementations

In addition to determining the bed height, the deposition velocity can also be calculated based on other measured parameters. Equation 7 below shows the relevant mathematical relationship:

$${V}_{no bed} = \frac{{Q}_{actual}}{{A}_{pipe}} \qquad Eq . 7$$

The deposition velocity can be bound by two inequality equations given by Equations 8 and 9. It is understood that a deposition velocity can be found when Vᵢₙₛₜᵣᵤₘₑₙₜ is greater than V_{no bed}, because it can imply that a solids bed formed in the pipeline according to sections presented above.

Vᵢₙₛₜᵣᵤₘₑₙₜ>V_{no bed} Eq. 8

Vᵢₙₛₜᵣᵤₘₑₙₜ−V_{no bed}>n·Vᵢₙₛₜᵣᵤₘₑₙₜ, where 0.05<n<0.2. Eq. 9

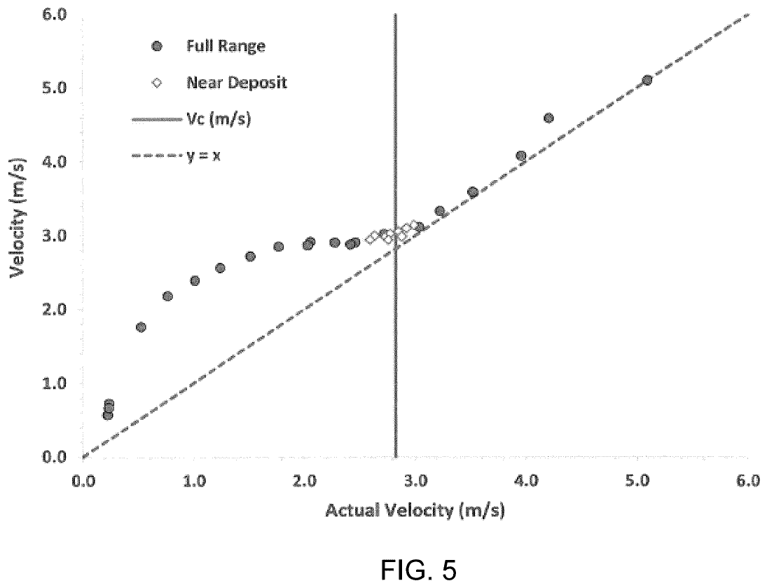

The deposition velocity can be determined by using a graph or correlation linking measured velocity data to no-bed velocity data, the relationship showing a deviation corresponding to a first estimate. FIG. 5 shows an example of a graph useful for determining the deposition velocity of a slurry pipeline linking actual velocity measurements to velocity measurements obtained by using a sonar-based flow meter.

It is noted that the actual velocity can be derived from the actual flow rate (Q_{actual}). Suitable techniques to obtain Q_{actual} are described above in the section entitled Flow rate measurements and bed dimension implementations. The sonar-based flow meter such as the CiDRA SONARtrac™ or the CiDRA SandTrac™ can provide the actual velocity whether there is presence of a bed or not. The Q_{actual} can still be overestimated if a bed is present since there is a cross-sectional bed area blocking a flow area for the slurry.

### Oil Sand Process Including the Method Described Above

The main objective of the method proposed herein is to mitigate slurry pipeline wear by operating the pipeline at or below the deposition velocity of the solids contained in the slurry. A process integrating the method of determining a bed dimension to transport a slurry is described below.

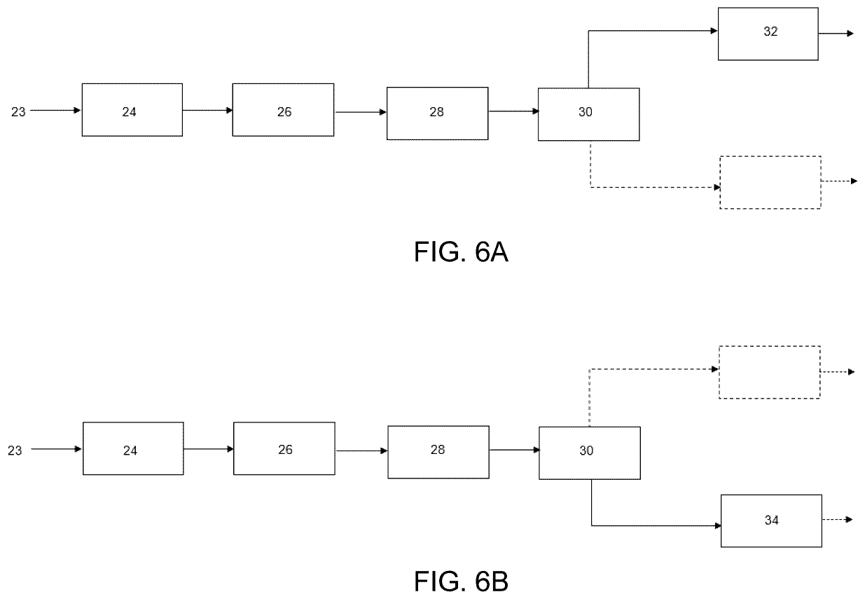

Referring to FIGS. 1, 6A and 6B, a process for operating a pipeline transporting a slurry can include pumping 24 a slurry material 23 through the pipeline, monitoring 26 the slurry, determining the bed dimension 28 according to the method described above, and adjusting operating conditions 30 of the pipeline, based at least in part on the bed height 8.

Adjusting the operating conditions of the pipeline 30 can include decreasing a flow rate 32 of the slurry to increase the bed height 8. According to FIG. 6B, adjusting the operating conditions 30 of the pipeline is performed by increasing the flow rate 34 of the slurry to decrease the bed height 8. Accordingly, the bed height 8 can be controlled by adjusting the slurry flow rate. By decreasing the slurry flow rate, velocity of the slurry can also decrease thus allowing more of the solids to settle and pack as a solids bed. On the other hand, by increasing the slurry flow rate, particles at the top of the solids bed can detach from the bed and be entrained by the flow of slurry above the solids bed. The bed height 8 can also be controlled by adding more water to lower a solids content of the slurry. A solids bed can be said to be formed once a grain-to-grain contact has been reached, which is equivalent to a maximum packing capacity. The maximum packing capacity can depend on nature of the solids making up the solids bed. In some implementations, the bed height can be controlled by increasing a tonnage of the slurry for a given water flow rate. Viscosity of the slurry circulating above the solids bed can also be modified to control the bed height. For example, an ore with a greater clay particles content can be fed to the pipeline to stimulate deposition of solid particles.

A pumping capacity of a pumping system allowing transport of the slurry 4 in the pipeline 2 can also be monitored to determine the presence of the solids bed in the pipeline 2.

In some implementations, the bed dimension can be a bed height and can be maintained between 5% and 25% of a diameter of the pipeline to keep the pipeline operating.

In order to determine the bed height along a pipeline, a plurality of Vᵢₙₛₜᵣᵤₘₑₙₜ readings can be taken at respective locations along the pipeline, in order to determine corresponding bed heights at these locations. In an oil sands hydrotransport pipeline, for example, a first bed height can be determined at a first location and a second bed height can be determined at as second location, the second location being downstream from the first location. The first location can be proximate to the Slurry Preparation Plant (rotary breaker, wet sizers, vibrating screens) while the second location can be far downstream proximate the primary separation vessel. The slurry flow can be adapted based on the first and second bed height. The first bed height and the second bed height can be different since bitumen can be liberated during transportation of the slurry thus modifying the particle size distribution along the pipeline. In particular, at the upstream location there are larger lumps of ore that include bitumen and mineral solids, while at the downstream location there are smaller particle sizes as the lumps have largely broken up during hydrotransport. Given the discrepancy between the particle size distribution at the upstream and downstream locations, it can be useful to have distinct flow rate meters at those locations to determine and control the bed heights along the pipeline.

In some implementations, smaller diameter pipes can be used in primary sections of the pipeline to become larger diameter pipes in further downstream sections of the pipeline. A solids bed can be formed in both types of pipes. It is thus of interest to perform measurements at these locations to monitor the beds heights of the smaller and bigger diameter pipes and take suitable corrective actions if necessary.

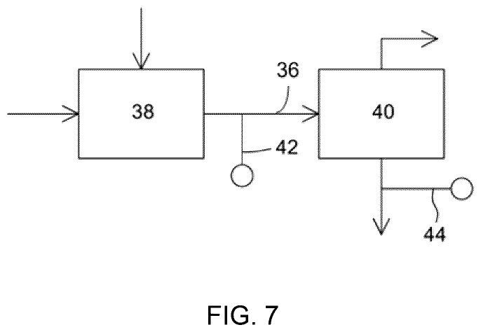

Referring to FIG. 7, the slurry being transported through the pipeline can be a hydrotransport slurry 36 produced by a rotary breaker 38 and supplied to a primary bitumen separation unit 40 and a tailings slurry including coarse mineral solids produced as an underflow stream from the separation unit 40. If the slurry is a tailings slurry, the solids bed can remain at a same height across an entire length of the pipeline as the mineral solids granulometry and make-up should remain relatively constant along the pipeline. If the slurry is a hydrotransport slurry, the bed height can vary along the pipeline given that particle size change along the pipeline.

### EXAMPLES & CALCULATIONS

The following examples 1 to 3 relate to the determination of a solid bed height and example 4 relates to the determination of a deposition velocity.

### Example 1

The voracity of the relationship

$${A}_{bed} = \frac{Δ Q}{{V}_{instrument}} \qquad ( Equation 5 )$$

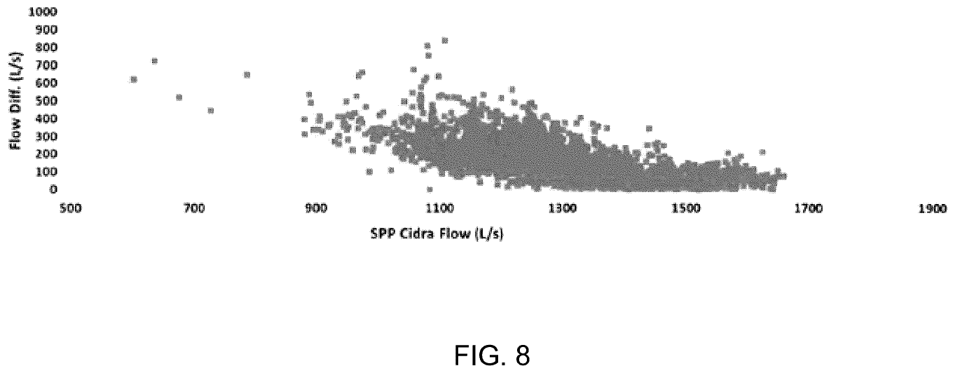

was tested using a commercial slurry pipeline and by observing the behaviour of ΔQ with the actual flow rates. A larger bed was expected at low flow rates and a consistent trend of ΔQ values at low flow rates was observed. This is shown in FIG. 8, which plots Flow Difference (L/s), i.e., ΔQ, on the y-axis versus SPP Cidra Flow (L/s), i.e., Flow Rate, on the x-axis. It can be seen from FIG. 8 that there was a definite correlation between ΔQ (Flow Difference (L/s)) and the Flow Rate (SPP Cidra Flow (L/s)). In particular, when ΔQ is close to zero, i.e., under 50 L/s, one would expect the flow rate to be high, as there would be very little bed formation; FIG. 8, in fact, shows that when ΔQ was below 50 L/s, the flow rates were high, ranging from about 1200 L/s to about 1650 L/s. However, when ΔQ was high, indicating a significant bed formation, the flow rate dramatically decreased, e.g., when ΔQ was between about 250 L/s to about 350 L/s, the general trend was that the flow rates were lower than about 1300 L/s and ranged between about 900 L/s to about 1300 L/s.

### Example 2

In this example, a known method for estimating bed height was compared to the method for measuring bed height provided herein. The known method used for estimating bed height in a pipeline involves applying a heat source to the outside of the pipe wall and measuring the energy required to keep the wall at a given temperature. See, for example, International Publication Number WO 2016/044866 and Canadian Patent No. 3,076,397. If this is done at a range of locations around the pipe diameter, the difference in the energy requirements at each location can be used to infer a bed height. By way of example, such a thermal based instrument can be used to measure the temperature at the top of a pipe and at the bottom of the pipe to determine bed height.

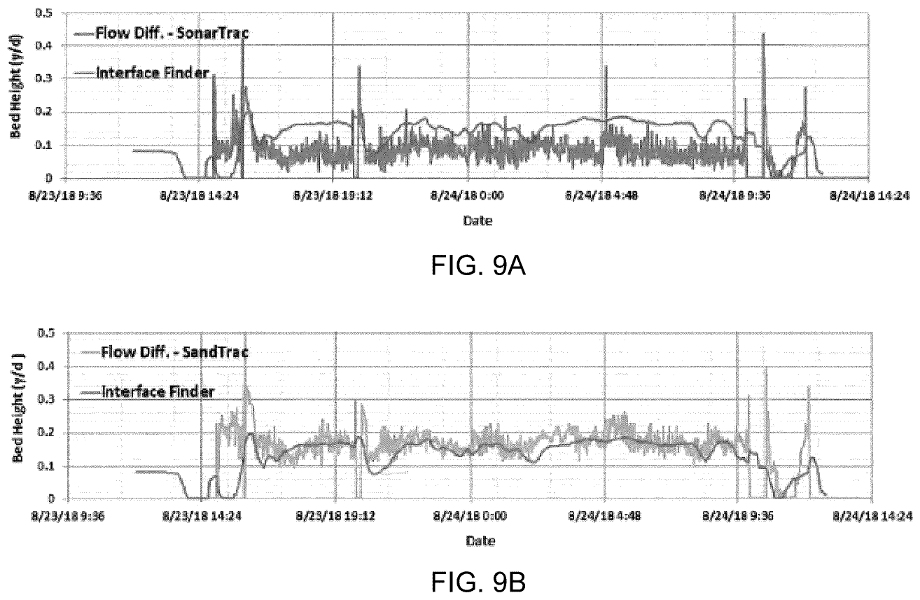

A comparison of the relative bed height using a heat-based bed detector (Interface Finder) and the relative bed height measured using the approach proposed in this application as tested on a commercial pipeline is shown in FIGS. 9A and 9B. The relative bed height as calculated using the thermal based instrument, which is referred to in FIGS. 9A and 9B as the “Interface Finder”, is shown as a solid red line. In FIG. 9A, the relative bed height using the present method was determined by using the CiDRA SONARtrac™, which determines the velocity at the center of the pipe, and in FIG. 9B, the relative bed height using the present method was determined by using the CiDRA SandTrac™ instrument, using velocity readings at the top of the pipe and at the 1.5 o'clock position of the pipe.

It can be seen from FIG. 9A that the flow difference of the present method trended well with the relative bed height measured by the thermal instrument CiDRA SONARtrac™. FIG. 9B, using the thermal instrument CiDRA SandTrac™, gave an even better correlation with the Interface Finder.

### Example 3

In this example, pilot experiments were done using a 10″ pilot loop with a clear pipeline section. By using a clear pipeline section, the actual bed height could be visually observed and, thus, a detailed measurement of bed height could be made.

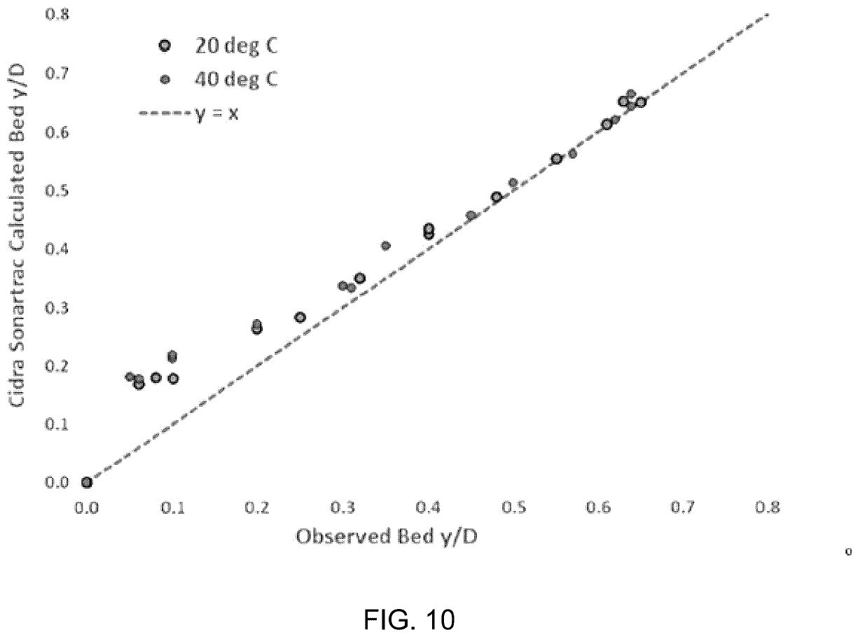

This data was compared to the bed height measured using the method provided herein (CiDRA SONARtrac™ was used in this example) and the results can be seen in FIG. 10. Data was collected at two different temperatures, namely, 20° C. (blue dots) and 40° C. (red dots). The CiDRA SONARtrac™ calculated bed (y/D) is on the y-axis and the observed bed (y/D) is on the x-axis. FIG. 10 shows a good correlation between CiDRA SONARtrac™ measured bed height and actual bed height, indicating that the approach outlined in this disclosure can provide a reasonable trend of bed height for beds with y/D<0.3 and an accurate reading for beds with a y/D>0.3. Since it was discovered by the present applicants that maintaining a stationary bed at or below 25% resulted in reduced pipeline wear at the 6 o'clock position of the pipe, the present method can be used to ensure that the stationary bed does not exceed 25% by being able to adjust the operating conditions when the stationary bed exceeds 25%.

### Example 4

In addition to providing an estimate of the bed height, the pilot experiments have also shown that the CiDRA SONARtrac™ velocity readings can be used to provide a reasonable estimate of the deposition velocity for a slurry. In these experiments, the flow loop included a smaller diameter (8 inches) vertical section with an electromagnetic flow meter on it for measuring the true flow in the pipe loop (i.e., this 8-inch section has no bed). The first estimate of the deposition velocity is when the centerline velocity (m/s) using the CiDRA SONARtrac™ and the true average pipe velocity start to deviate, as shown by the vertical line in FIG. 5. It is at this point, the bed has disappeared, which is the very definition of deposition velocity. The second estimate of the deposition velocity is the velocity above the bed; however, this estimate is only true for some range of flows below the deposition velocity. On FIG. 5, this is the flat section of CiDRA velocities from about 2-3 m/s actual velocity. The bed in the pipeline will size itself to keep the velocity above it equal to the deposition velocity and this is what is happening between 2-3 m/s on the plot (at a constant CiDRA velocity of 3 m/s). This does not persist to lower velocities as there is a fixed amount of sand in the line and at too low a velocity all the sand is already in the bed, i.e., there is not enough sand left to make the bed increase more. This observation offers an economical way to use a Cidra SONARtrac™ style instrument to determine the onset of deposition in a commercial pipeline.

Several alternative implementations and examples have been described and illustrated herein. The implementations of the technology described above are intended to be exemplary only. The implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

References in the specification to “one embodiment”, “an embodiment”, “an implementation”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the aspects of the disclosure may be drafted to exclude any optional element. As such, this statement is intended to serve as antecedent basis for the use of exclusive terminology, such as “solely,” “only,” and the like, in connection with the recitation of elements or use of a “negative” limitation. The terms “preferably,” “preferred,” “prefer,” “optionally,” “may,” and similar terms are used to indicate that an item, condition or step being referred to is an optional (not required) feature.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A method for determining a bed dimension of a solids bed formed in a pipeline transporting an oil sands slurry, the method comprising:
measuring an actual flow rate (Q_{actual}) of the slurry being transported through the pipeline;
obtaining at least one measured velocity (Vᵢₙₛₜᵣᵤₘₑₙₜ) of the slurry being transported;
determining a velocity-derived flow rate (Qᵢₙₛₜᵣᵤₘₑₙₜ) based on Vᵢₙₛₜᵣᵤₘₑₙₜ and a cross-sectional size property of the pipeline;
determining a cross-sectional bed size property based on a flow rate difference (ΔQ) between the Qᵢₙₛₜᵣᵤₘₑₙₜ and the Q_{actual} as well as the Vᵢₙₛₜᵣᵤₘₑₙₜ; and
determining the bed dimension based on the cross-sectional bed size property.

2. The method of claim 1, wherein the bed dimension is a bed height.

3. The method of claim 2, wherein the cross-sectional size property of the pipeline is the cross-sectional area of the pipeline (Aₚᵢₚₑ), the cross-sectional bed size property is a cross-sectional bed area (A_{bed}) and the bed height is determined based on the A_{bed}.

4. The method of claim 3, wherein the Qᵢₙₛₜᵣᵤₘₑₙₜ is determined by multiplying the Vᵢₙₛₜᵣᵤₘₑₙₜ by the Aₚᵢₚₑ.

5. The method of claim 3, wherein the A_{bed} is determined by the following: (Qᵢₙₛₜᵣᵤₘₑₙₜ−Q_{actual})/Vᵢₙₛₜᵣᵤₘₑₙₜ.

6. The method of claim 1, wherein the bed dimension is determined using the cross-sectional bed size property according to a trigonometrical relationship.

7. The method of claim 6, wherein the trigonometrical relationship comprises a disk segment equation.

8. The method of claim 7, wherein the bed dimension is a bed height, wherein the disk segment equation is
$${A}_{bed} = \frac{{D}^{2}}{4} {cos}^{- 1} ( 1 - 2 ( \frac{y}{D} ) ) - ( \frac{D}{2} - y ) \sqrt{( Dy - {y}^{2} )} ,$$
and wherein D is a diameter of the pipeline, and y is the bed height.

9. The method of claim 1, wherein determining the bed dimension is performed using an iterative process.

10. The method of claim 1, wherein the measuring of the Q_{actual} is performed using a volume flow meter or a mass flow meter and density measurement.

11. The method of claim 10, wherein the mass flow meter is an electromagnetic flow meter, and the volume flow meter is a sonar-based flow meter.

12. The method of claim 1, wherein the Vᵢₙₛₜᵣᵤₘₑₙₜ is measured using a sonar-based flow meter.

13. The method of claim 12, wherein the Vᵢₙₛₜᵣᵤₘₑₙₜ is measured as a single velocity at or near a centerline of the pipeline.

14. The method of claim 12, wherein the Vᵢₙₛₜᵣᵤₘₑₙₜ is determined based on at least two velocity measurements taken at different heights in the pipeline.

15. The method of claim 14, wherein the at least two velocity measurements are taken between a top of the pipeline and a 3 o'clock position of the pipeline.

16. The method of claim 1, wherein the slurry is a hydrotransport slurry supplied from a Slurry Preparation Plant to a primary bitumen separation unit, or a tailings slurry comprising coarse mineral solids.

17. A method for determining a deposition velocity of a solids bed formed in a pipeline transporting an oil sands slurry, the method comprising:
obtaining a no-bed velocity when no solids bed is formed in the pipeline; and
obtaining at least one measured velocity of the slurry being transported,
wherein the at least one measured velocity is greater than the no-bed velocity.

18. The method of claim 17, further comprising using a correlation linking the measured velocity data to the no-bed velocity data, the correlation providing a deviation corresponding to a first indication of the deposition velocity.

19. A process for operating a pipeline transporting a slurry, comprising:
pumping a slurry flow through a pipeline;
monitoring the slurry and determining the bed dimension according to the method defined in claim 1; and
adjusting operating conditions of the slurry based at least in part on the bed dimension.

20. The process of claim 19, wherein the adjusting of the operating conditions comprises: decreasing a flow rate of the slurry to increase the bed dimension or increasing the flow rate of the slurry to decrease the bed dimension; wherein the process further comprises controlling the bed dimension by adjusting the slurry flow, by adjusting a tonnage for a given water flow rate or by adjusting a viscosity of the slurry, and wherein adjusting the viscosity of the slurry is performed by using an ore with a higher clay particles content or increasing water content; wherein the bed dimension is a bed height which is maintained between 5% and 25% of a diameter of the pipeline; wherein the process comprises obtaining a plurality of Vᵢₙₛₜᵣᵤₘₑₙₜ readings at respective locations along the pipeline, and determining corresponding bed dimensions at the location, and wherein a first bed dimension is determined at a first location of an oil sands hydrotransport pipeline and a second bed dimension is determined at a second location that is downstream from the first location, and the slurry flow is adapted based on the first and second bed dimensions.
